(19) United States
(12) Patent Application Publication
(10) Pub. No.: US 2002/0030742 A1
(43) Pub. Date: Mar. 14, 2002

(54) Employing electomagnetic by-product radiation for object tracking

(76) Inventors: James A. Aman, Souderton, PA (US); William R. Haller, Bethlehem, PA (US)

Correspondence Address: James A. Aman, 134 Bridle View Way, Souderton, PA, 18964, US

(21) Appl. No.: 09/881,430

(22) Filed: Jun. 14, 2001

Related U.S. Application Data
(63) Continuation-in-part of application No. 09/197,219, filed on Nov. 20, 1998.

(51) Int. Cl. H04N 5/225

(52) U.S. Cl. 348/169

(57) ABSTRACT

A system 200 for tracking the movement of multiple objects within a predefined area using a combination of overhead X-Y filming cameras 125 and tracking cameras 124 with attached frequency selective filter 124f. Also employed is perspective Z filming cameras 125 and tracking cameras 124 with filter 124f The preferred energy source is existing rink lamp 10 that emits electromagnetic by-product radiation in either the UV range for typical Metal Halide lamps or the IR range for typical Xenon Arc lamps. Foreground objects to be tracked such as player 110, jersey 105, stick 104 and puck 103 have been marked to include some form of frequency selective reflective material, such reflective material 20a, retroreflective material 20b or fluorescent material 20c. Prior to marking, foreground objects such as jersey 105 and stick 104 have first been treated with either a UV or IR absorbent compound such as 24 that absorbs incident tracking energy rays. In the situation where IR is used as the tracking energy, player 110 will typically emit unwanted interference ray 13c in which case the inside of jersey 105 may be additionally treated with IR an absorbent compound such as 26.

### FIELD OF INVENTION

The present invention relates to machine vision systems for tracking the movement of multiple objects within a predefined area.

### DESCRIPTION OF PRIOR ART

The use of machine vision-based tracking systems designed to follow the movement of multiple objects, especially people, is receiving increased attention as both camera and computer technology continues to improve. One such system has been proposed by the present inventors in their co-pending patent application Ser. No. 09/197,219 entitled Multiple Object Tracking System that was filed on Nov. 20, 1998. The disclosure of this earlier application is incorporated by reference. In this application, a system was described that essentially viewed the objects to be tracked in the “non-visible” spectrum of energies, most desirably ultraviolet (UV) or infrared (R). The objects to be tracked were first marked with a “reflective ink” specifically chosen to maximize the amount of reflected non-visible energy. After this, special lamps where introduced into the tracked space (predefined area) that emitted the desired non-visible energy. And finally, industrial video cameras were fitted with filters specifically chosen to block all visible light thereby only passing the emitted and then reflected non-visible energy. While this system accomplished its goal of simplifying the amount of data to be received by the tracking computers, additional novel and useful improvements are possible.

First, the special lamps that have been added to the predefined area have several drawbacks as follows:

1. They require additional energy to light and therefore represent an added ongoing cost that must be incurred by the operating facility.

2. They are adding additional energy into their environment, which in the case of a sporting event such as hockey causes the undesirable side effect of raising the ambient temperature. This rise in temperature creates an additional cost to remove the extra heat.

3. Special fixtures must be created to hold and operate the lamps within the facility thereby increasing the system installation costs.

4. The lamps themselves will eventually bum out. A single sheet of ice within a hockey rink may require 60 lamps that may cost between $20 to $40 each, representing a lamp cost of $1,200 to $2,400 per sheet.

5. These lights also create additional maintenance problems, as they will hang above the ice surface and are not easy to replace once they burn out.

In addition to the lamps, the aforementioned invention called for the use of reflective ink to mark the objects being tracked. The energy loss from dispersed light such as would be created by a reflective surface is on the order of 1/r² where “r” is the distance between the reflective surface and the energy “capture” device. Since the ceilings in a typical hockey rink are between 30 to 40 feet above the ice surface, a considerable loss in energy would be experienced as the emitted non-visible energy traveled from the lamps above, down to the marks on the players and then back up to the cameras. This additional loss of energy due to the poor reflective properties of typical ink could only be compensated for by increasing the amount of emitted non-visible energy thereby exacerbating the aforementioned lamp problems.

Energy inefficiency is important to a facility, especially an air conditioned arena such as a hockey rink. According to an article placed on the Internet by TCorp., Inc., an energy management service company, “lighting counts for 7% of the radiation heat load the compressors must remove plus 12% of the electrical energy use for an estimated 16% of the total energy used by a rink.” This statement is of course referring to existing lighting used to illuminate the ice surface for the skaters and does not account for any additional lighting to be used for object tracking.

And finally, the prior system did not fully accomplish its goal of reducing the amount of object information to be processed by simply switching to a non-visible frequency. This is due to the fact that both the existing background, for example the sheet of ice in a rink, and the foreground objects, for example players and their equipment, reflect both UV and IR energy. While this reflection is “dim”, it is still potentially “visible” to the filtered cameras thereby creating additional information that must be analyzed.

While the present invention will be specified in reference to one particular example of multi-object tracking as will be described forthwith, this specification should not be construed as a limitation on the scope of the invention, but rather as an exemplification of preferred embodiments thereof The inventors envision many related uses of the apparatus and methods herein disclosed only some of which will be mentioned in the conclusion to this specification. For purposes of teaching the novel aspects of this invention, the example of multi-object tracking is that of a sporting event such as hockey. The particular aspect of hockey that makes it a more challenging machine vision application with respect to energy efficiency is the enclosed air-conditioned arena that tends to react negatively to any additional energies added for the purposes of object tracking.

As previously mentioned, the typical recreational ice hockey facility may have upwards of 60 lamps hanging above a single sheet of ice. Many of these facilities use what are known as Metal Halide HID (Nigh Intensity Discharge) lamps to illuminate their rinks. One such example of this type of lamp is the Sylvania 400 Watt Metal Halide Lamp whose part number is M59-R-M400/U. The emission specification for this particular lamp reveals a significant discharge of energy in the range of 315 to 400 nm. This particular band of frequencies is also referred to as UVA and is not visible to the human eye. Hence, all of this UVA light currently being discharged is an unused by-product and furthermore undesirable energy within the ice hockey facility since it does not serve to illuminate the players for the audience.

It is possible to employ this currently wasted energy in a useful manner to assist in the machine vision tracking of the players and game equipment as outlined in the inventors' co-pending application. Using this UVA energy will either reduce or eliminate the need to add special “non-visible” energy-emitting lamps as originally called for in this prior invention. Reducing or eliminating these additional special lamps will have a positive effect on the overall rink energy efficiency as well as the cost to construct, install, operate and maintain the proposed object tracking system.

Although there is an appreciable amount of UVA currently being emitted by lamps such as the Sylvania M59-R-M400/U, it is still desirable to optimize the detection of this energy within the tracking system. This optimization is a two-fold process of both reducing noise and increasing signal. The noise within this particular type of system is represented by the UVA energy being reflected off of anything other than the tracking ink marks and patches. This reflected UVA energy may subsequently be absorbed by the CCD camera array thereby making “visible” to the camera an undesirable object. In order to reduce the noise created within the tracking video images it is possible to controllably reduce this undesirable reflected energy.

There are many compounds described in general as UV blockers. Examples of such compounds that are found in skin care products include Para aminobenzoic acid (PABA), Benzophenones, Cinnamates and Salicylates. These help to reduce the damaging effect of UV radiation by absorbing both the more harmful UVB energy (290-315 nm) as well as VA. Many other more or less absorbent compounds and materials exist including glass, plastic and Parsol to name a few. The choice of the specific ingredient to use as a UV blocker is highly dependent upon the object surface material to be treated. Within a typical athletic event the following types of “tracked object” foreground surfaces may be found:

Fabrics (players' jerseys and clothing)

Wood (game equipment such as a hockey stick or baseball bat)

Plastic (protective gear such as a player's helmet)

Leather (game equipment such as hockey pads, a baseball, baseball glove or football)

Metal (game equipment such as helmet face masks, ice skate blades and certain types of hockey sticks)

Skin and hair (still exposed on the players)

The aforementioned ingredients are typically found in sunscreens that can be applied to at least the player's skin. Several products exist in the marketplace such as “Protectall,” manufactured by Protectall, Inc., that may be applied to many different surfaces and acts as a “cleaner, polish, wax, treatment and protectant.” The “protectant” nature of this particular product is its UV absorber that works to thwart the chemical breakdown that can be caused by UV light ultimately leading to discoloration and other adverse effects. When a compound such as “Protectall” is applied to the foreground surfaces such as fabrics, wood, plastic, leather and metal it will have the unanticipated side effect of reducing the “visibility” of these objects to a UV based vision system. This reduction in reflected UVA will have a positive “noise reducing” influence on the vision system disclosed in the

Multi-Object Tracking System application when UV light such as that emitted by Metal Halide Lamps is used as the tracking energy.

The second system optimization to conserve energy is to increase the tracking signal received by the vision system cameras without increasing the tracking energy output by the lamps. The basic solution to this problem is the opposite required for the elimination of noise or unwanted reflections. Therefore, what is needed is a mechanism to increase the UVA reflectivity of the selected portions of the object surfaces that are used as tracking points. For instance, it is desirable to follow the motion of all key locations on a player such as the head, shoulders, elbows, hands, waists, knees and feet. There are paint, ink and film products currently on the market that act as UV reflectors that may be applied to various surfaces as previously described, namely fabrics, wood, plastic, leather, metal and skin.

Such products typically contain some form of what is referred to as “physical UV blockers.” Rather than absorbing UV rays, these compounds reflect them. Titanium dioxide and zinc oxide are the best known of this group. New technological advances have led to the development of UV blockers made of particles so small that the human eye does not perceive them and yet they still reflect UV light.

A company called Collaborative Laboratories produces one such example of these microscopic physical blockers. Their general class of products is referred to as “Micronized Titanium Dioxide” that they describe as having the following benefits:

“What are the advantages of micronized titanium dioxide and how can using TiOsperse™ offer formulators an array of benefits for their finished formulations? The benefits you will derive are:

Extremely small particle size

Transparent to visible light

Greater surface area

Reflects and scatters UV light more effectively than pigmentary titanium dioxide.”

Another example of a new UV reflective material is described by its manufacturer CLCEO Corp. as follows:

“a revolutionary new technology for fabricating a broadband, thin film reflective circular polarizer having previously unheard-of properties. The reflection band of this polarizer can be engineered to any portion of the spectrum from the UV through the near-infrared. The films can also be broken into thin flakes for incorporation into heat and UV protective paints and balms, and can be used as completely colorless IR and UV reflective films . . .

. . . This polarizer material is unique in that it can be applied as a uniform film or (using a Reveo proprietary process) it can be broken into smaller flakes that are then distributed as a pigment in a carrier. A CLC IR film can be applied directly to architectural or automotive windows to minimize heat transmission through the window. Since this film is totally transparent in the visible region, it is haze-free and does not interfere with the aesthetic qualities or degrade the brightness of the window. Similarly, a protective UV reflecting film can be applied to reduce solar UV-induced fading and aging of fabrics and other materials.

An IR-reflecting paint can be fabricated into a clear overcoat for virtually any surface. In architectural applications, for example, it would enable an exterior painted building surface to reflect the heating portion of solar radiation. Presently, buildings in hot climates are painted white or light colors to prevent solar heating during the day. A transparent, IR reflecting overcoat will enable architects and designers to use the color of their choice, while at the same time minimizing solar heating and the load on the building's cooling system.

Another application is in suntan lotion and related products. Here the IR-reflecting flakes can provide an unprecedented cooling effect for the consumer. Furthermore, published reports indicate that most sunscreen lotions protect only against UVB radiation. A lotion incorporating the Reveo UV-reflecting flakes can provide heretofore unheard-of complete UVA and UVB protection in a colorless, non-toxic lotion.”

And finally, The Boeing Company has also created UV reflective materials that they describe as follows:

“In two filings now before the US Patent and Trademark Office, McDonnell Douglas has disclosed various multilayer dielectric thin film structures, deposited on glass, plastic or metal, which reflect greater than 99% of longwave UV while improving transmittance in the visible rather than decreasing it as may be the case with other UV blocking methods. Reflectance is reduced to less than 0.5% over most of the visible spectrum as compared to 4% reflectance typical for uncoated glass or plastics.

Since the coatings work by reflection rather than absorption, no heating effects are produced. The broadband AR coating results in a nearly neutral color to the eye in transmission. This coating, externally applied, can be used on a wide variety of materials, and tailored to specific needs.”

Any of these aforementioned new or existing UV reflective compounds may be used as an ingredient in the marker attached or placed upon the foreground object to be tracked making this marker more “visible” to a UV based camera system.

In addition to these types of reflective materials that were called for in the co-pending application there is also a class of paints referred to as retro-reflective. These materials are based upon microscopic “spherical glass beads” that differentiate themselves by causing incident energy to be redirected back in the direction from which it was received as opposed to the multi-directional dispersion of typical “flat” paints such as previously described. One such manufacturer of these materials is the 3M Corporation that claims that its retroreflective paint is 1500 times as reflective as white pigment. Typical uses for these paints and inks have been to mark clothing worn by work crews that may be in the proximity of moving vehicles in low light conditions.

Another manufacturer of such paints is Reflective Technology Industries, Ltd. that makes a series of retroreflective paints suitable for application on fabrics, plastic, wood, metal and most other surfaces typical for normal paint use. They describe this class of retro-reflective paints as follows:

“Light is focussed on the coated back surface of millions of micro glass beads where it is retroreflected back through the beads in the direction from which it came.”

While this type of paint has been developed for visible light applications, when used as an object marker in a UV based object tracking system, it will have the unanticipated additional benefit of making these markers more “visible” to the tracking cameras. This type of retroreflective paint will provide increased signal strength over the originally conceived reflective paint solutions specified in the co-pending application. This conservation of emitted signal will thereby help to reduce the power output requirements of the chosen UV tracking energy having a positive effect on the overall energy efficiency of the game event arena.

Another possible solution for the maximization of tracking signal is the use of fluorescent materials as opposed to the reflective or retroreflective. The properties of a fluorescent compound are such that it will receive energy of a higher frequency and then upon absorption of this energy emit heat plus energy of a lower frequency. A typical example of this type of material is the “invisible ink” that is used to mark an individual's hand as they temporarily leave an amusement park. This mark can only be seen when the person's hand is placed under a black light that is a narrow band of energy at the higher end of visible light, near UVA. Once this black light strikes the fluorescent material the material radiates a visible wavelength of energy (of a lower frequency).

Metal Halide Lamps in particular, and any other lamps used to light a sporting arena in general, will emit most of their energy in the visible spectrum as opposed to any unused by-product in the UV or IR range. It would be very beneficial to convert some of this visible energy into the lower frequency IR energy that could then be used for tracking through the mechanism of fluorescence. Hence, even a lamp that emitted only visible light could be used to indirectly create the tracking energy.

Using IR as a tracking energy as opposed to UV has at least one advantage for a hockey rink application in that the ice surface will not reflect IR therefore reducing unwanted noise. One of the challenges to this type of solution would be to eliminate the IR radiation being naturally emitted by the player's bodies especially as they exert energy and therefore heat. However, a novel use of the IR reflective materials previously discussed such as those manufactured by CLCEO Corp. would solve this problem. By lining the players gear and/or jersey with this reflective material this will tend to reflect the players emitted IR energy back towards the player. Furthermore, by placing an IR absorptive compound on the outside of the players gear and/or jersey, the player will also absorb any stray IR energy that is not reflected, retroreflected or fluoresced off the designated tracking ink marks or patches.

Therefore, given the state of the art in Metal Halide and other HID light bulbs as well as energy absorptive compounds, retroreflective as well as fluorescent paints and inks it is possible to create a more energy efficient multi-object tracking system than previously disclosed by the prior art.

Objects and Advantages

Accordingly, the objects and advantages of the present invention are to provide a system for tracking multiple objects within a predefined area with the following additional capabilities:

1 to provide a system capable of employing the unused by-product non-visible energy such as UV or IR already being emitted by the visible lighting system currently in place at a given arena or facility thereby reducing or eliminating the requirement to add additional tracking energy;

2 to provide a system capable of converting the existing visible frequencies of light already being emitted by the lighting system currently in place at a given area into preferably a non-visible tracking frequency such as IR thereby reducing or eliminating the requirement to add additional tracking energy;

3 to provide a system capable of reducing the noise created by emitted tracking energy reflecting off object surfaces that are not intended to be tracked;

4 to provide a system capable of reducing the noise created by interfering electromagnetic frequencies being emitted by tracked objects such as a player that overlap the tracking energy frequencies;

5 to provide a system capable of increasing the signal received by the tracking cameras as reflected off the object surfaces that are intended to be tracked; and

6 to provide a system that has minimal to no negative energy effect on the arena or facility into which it is placed.

Further objects and advantages are to provide a cost efficient system to build, install and maintain with a minimum of moving parts that is capable of operating under a range of temperature conditions. Still further objects and advantages of the present invention will become apparent from a consideration of the drawings and ensuing description.

### DESCRIPTION OF THE DRAWINGS

FIG. 1 is a side view drawing of a typical High Intensity Discharge (HID) lamp of the type often used to illuminated large open spaces such as a sporting arena or facility, further depicting the spread of emitted electromagnetic frequencies ranging from ultraviolet through visible light into infrared.

FIG. 2a is a side view drawing of the same HID lamp showing its emitted energy being dispersed in multiple directions as it strikes a typical reflective material.

FIG. 2b is a side view drawing of the same HID lamp showing its emitted energy being redirected back towards the lamp as it strikes a typical retroreflective material.

FIG. 2c is a side view drawing of the same HID lamp showing its emitted energy being fluoresced and then dispersed in multiple directions back towards the lamp as it strikes a typical fluorescent material.

FIG. 3a is a block diagram depicting the background, multiple foreground objects as well as specially placed tracking marks that are potentially in the view of the tracking system cameras, all with a uniform reflectivity to the emitted tracking energy.

FIG. 3b is a block diagram depicting the same background, multiple foreground objects as well as specially placed tracking marks as shown in FIG. 3a where the foreground objects have been treated with an applique capable of absorbing the emitted tracking energy thereby creating a greater contrast between the foreground objects and the tracking marks that have been placed upon them.

FIG. 3c is a block diagram depicting the same background, multiple foreground objects as well as specially placed tracking marks as shown in FIG. 3a where the special marks have been treated with an applique capable of absorbing the emitted tracking energy thereby creating a greater contrast between the foreground objects and the tracking marks that have been placed upon them.

FIG. 4a is a block diagram depicting the background, multiple naturally reflective foreground objects as well as specially placed tracking marks that are potentially in the view of the tracking system cameras similar to those depicted in FIG. 3a except that the background is naturally absorptive of the emitted tracking energy.

FIG. 4b is a block diagram depicting the same background, multiple naturally reflective foreground objects as well as specially placed tracking marks as shown in FIG. 4a where the foreground objects have been treated with a compound capable of absorbing the emitted tracking energy thereby creating a greater contrast between the foreground objects and the tracking marks that have been placed upon them.

FIG. 4c is a block diagram depicting the same background, multiple naturally reflective foreground objects as well as specially placed tracking marks as shown in FIG. 4a where the special marks have been treated with a compound capable of absorbing the emitted tracking energy thereby creating a greater contrast between the foreground objects and the tracking marks that have been placed upon them.

FIG. 5 is a top view drawing of the preferred embodiment of the present invention depicting an array of overhead X-Y tracking cameras that when taken together form a field of view encompassing the skating and bench area within an ice hockey arena. Also depicted are perspective Z tracking camera sets behind each goal, automatic pan, tilt and zoom perspective filming cameras as well as a single representative player and puck.

FIG. 6a is a set of three perspective drawings depicting atypical player's jersey, typical player's pads with tracking patches in place and then a combination of the jersey over the pads with patches.

FIG. 6b is a set of two perspective drawings depicting a hockey puck as well as a typical player's hockey stick, where each has been augmented to include tracking ink on at least some portion of its outer surfaces.

FIG. 6c is a set of two perspective drawings depicting a typical hockey player's helmet which has been augmented to include tracking stickers on at least some top portion of its outer surface.

FIG. 7a is a cutaway depiction of a player's jersey to which a tracking energy absorptive compound as well as a tracking patch have been applied showing how the resultant foreground object will respond to the tracking system.

FIG. 7b is exactly similar to FIG. 7a except that an energy absorptive compound has been additionally added to the inside lining of the player's jersey thereby favorably changing the foreground object's response to the tracking system.

FIG. 8a is a perspective drawing of a typical hockey player's pads, helmet, stick and puck being captured from an overhead X-Y filming camera and displayed on a viewing screen.

FIG. 8b is a perspective drawing similar to FIG. 8a except that now tracking ink has been added to the hockey stick and puck, tracking patches have been added to the pads and tracking stickers to the helmet. In addition, a tracking energy source as well as a frequency-matching filter have been added to the overhead X-Y filming camera making it a tracking camera.

FIG. 8c is a perspective drawing similar to FIG. 8b except that now all of the foreground objects except the tracking marks have been treated with a energy absorptive compound. This compound is capable of absorbing the non-visible frequencies of energy that are being used by the tracking system.

### DETAILED DESCRIPTION

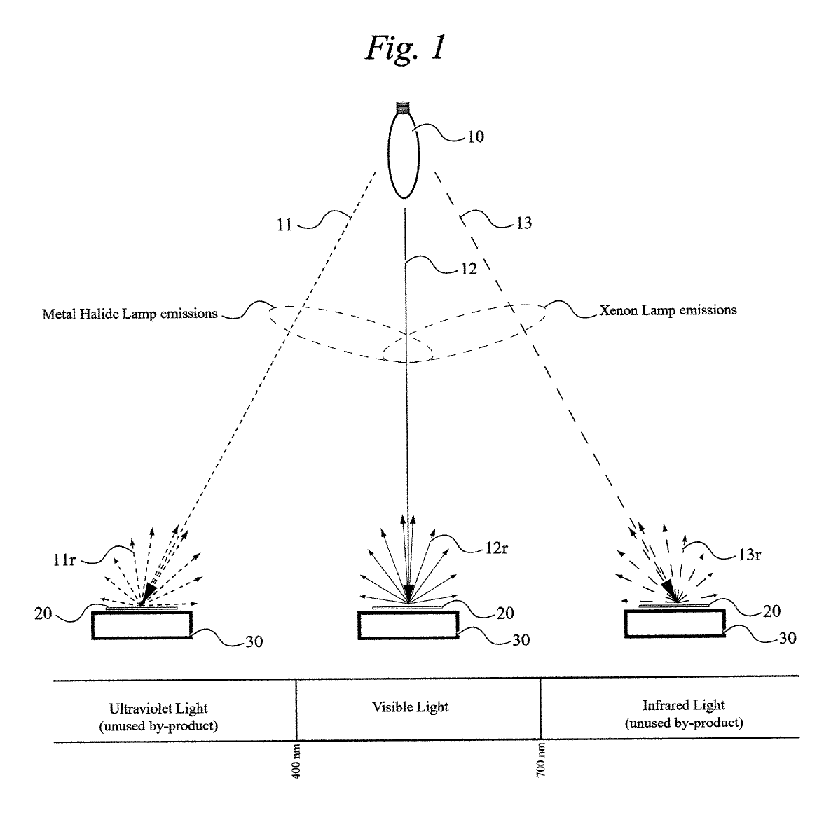

Referring to FIG. 1 there is shown a side view drawing of a typical rink lamp 10, two example types of which are either a Metal Halide Lamp or a Xenon Arc Lamp. The purpose of both of these types of lamps 10 within an arena application is to emit electromagnetic energy in the visible light spectrum between the frequencies of 400 to 700 nm as depicted by visible light ray 12. Ray 12 will then propagate through the atmosphere until striking reflective material 20 that has been applied to foreground object 30 subsequently causing reflected rays 12r. In the case where rink lamp 10 is of the Metal Halide type, then an additional by-product such as unused UV energy 11 is also emitted. Ray 11 will then propagate through the atmosphere until striking reflective material 20 that has been applied to foreground object 30 subsequently causing reflected UV energy 11r. In the case where lamp 10 is of the Xenon Lamp emissions type, then an additional by-product such as unused IR energy 13 is also emitted. Ray 13 will then propagate through the atmosphere until striking reflective material 20 that has been applied to foreground object 30 subsequently causing reflected IR energy 13r.

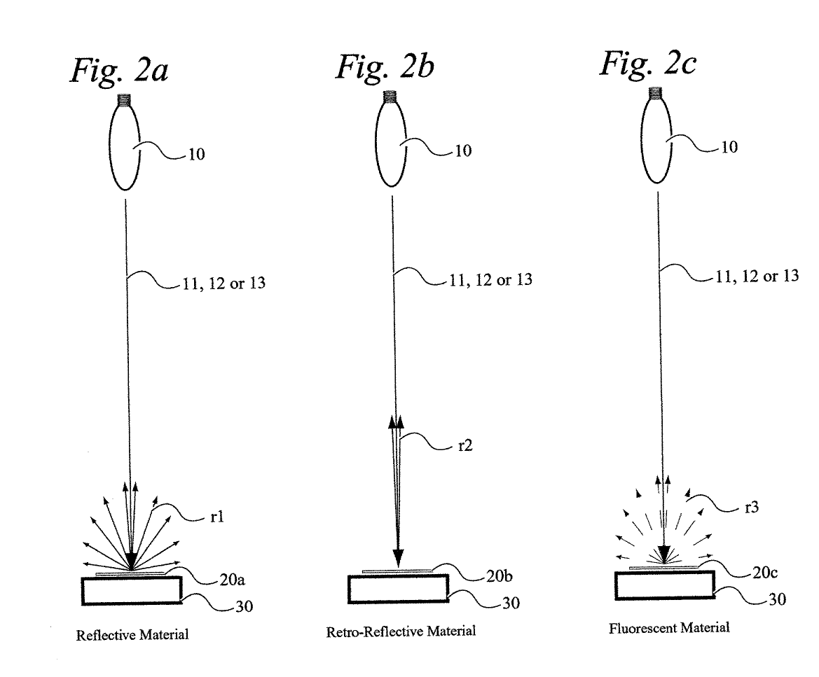

Referring now to FIG. 2a, rink lamp 10 is further depicted emitting one or more rays 11, 12 or 13 that strike reflective material 20a that has been applied to object 30 subsequently causing multi-directional reflected rays r1 similar to those anticipated in the co-pending application for a Multiple Object Tracking System.

Referring now to FIG. 2b, rink lamp 10 is further depicted emitting one or more rays 11, 12 or 13 that strike retroreflective material 20b that has been applied to object 30 subsequently causing retroreflected rays r2.

Referring now to FIG. 2c, rink lamp 10 is further depicted emitting one or more rays 11, 12 or 13 that strike fluorescent material 20c that has been applied to object 30 subsequently causing multi-directional changed frequency rays r3.

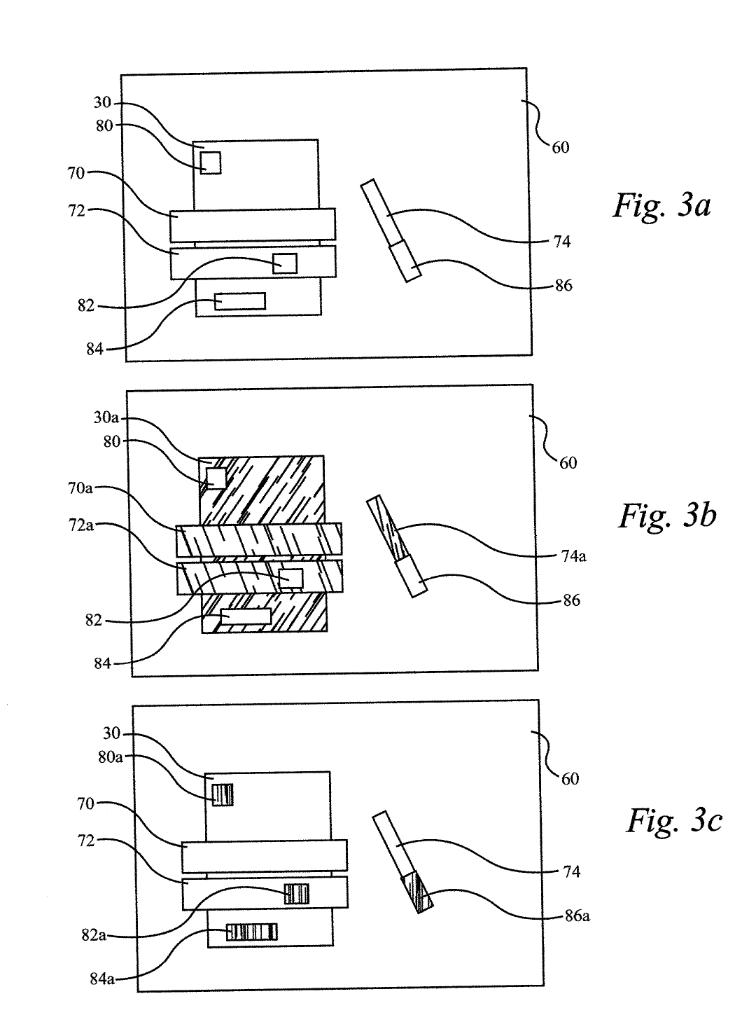

Referring now to FIG. 3a, there is shown a naturally reflective background 60 upon which at least one naturally reflective object 30 to be tracked transverses. Attached to reflective object 30 are one or more naturally reflective articles 70 and 72. Placed onto object 30 are reflective markers 80 and 84. Placed onto article 72 is reflective marker 82. Also present near object 30 is equipment 74 onto which reflective marker 86 has been placed.

Referring now to FIG. 3b, there is shown naturally reflective background 60 upon which the naturally reflective object 30 depicted in FIG. 3a has been treated and is now absorptive object 30a. Naturally reflective articles 70 and 72 have also been treated and are now shown as absorptive articles 70a and 72a. Reflective markers 80 and 84 are now shown as placed onto absorptive object 30a while reflective marker 82 is placed onto absorptive article 72a. Furthermore naturally reflective equipment 74 has been treated and is shown as absorptive equipment 74a upon which reflective marker 86 has been placed.

Referring now to FIG. 3c, there is shown naturally reflective background 60 and object 30. Placed onto reflective object 30 are absorptive markers 80a and 84a as well as reflective articles 70 and 72. Placed onto article 72 is absorptive marker 82a. Near object 30 is reflective equipment 74 unto which absorptive marker 86a has been placed.

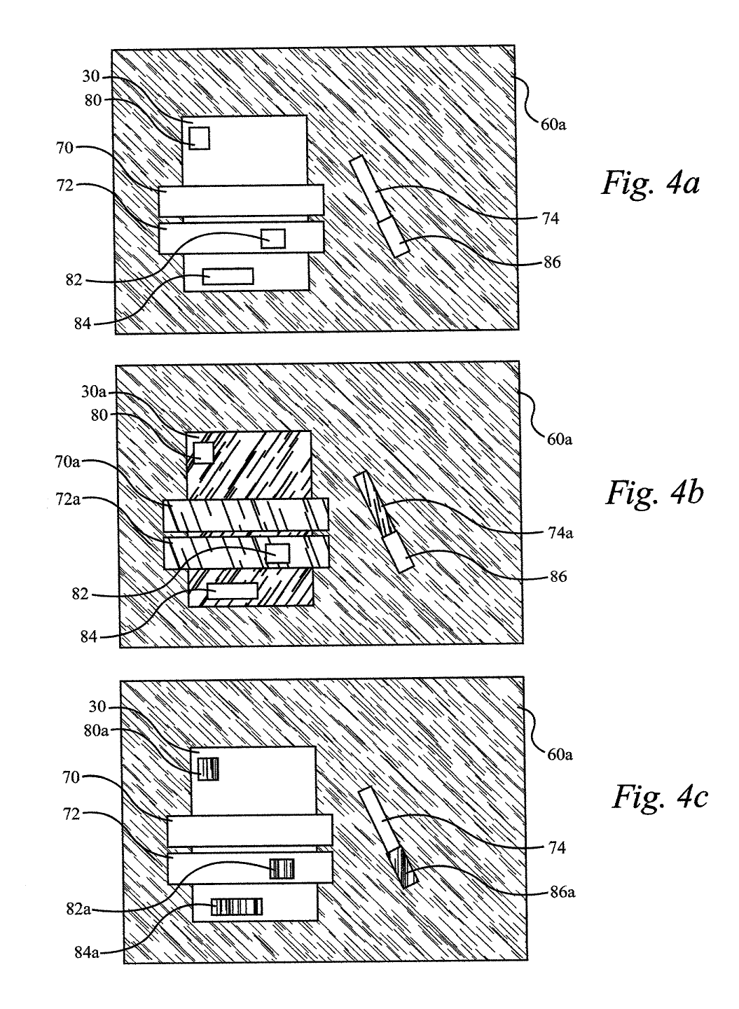

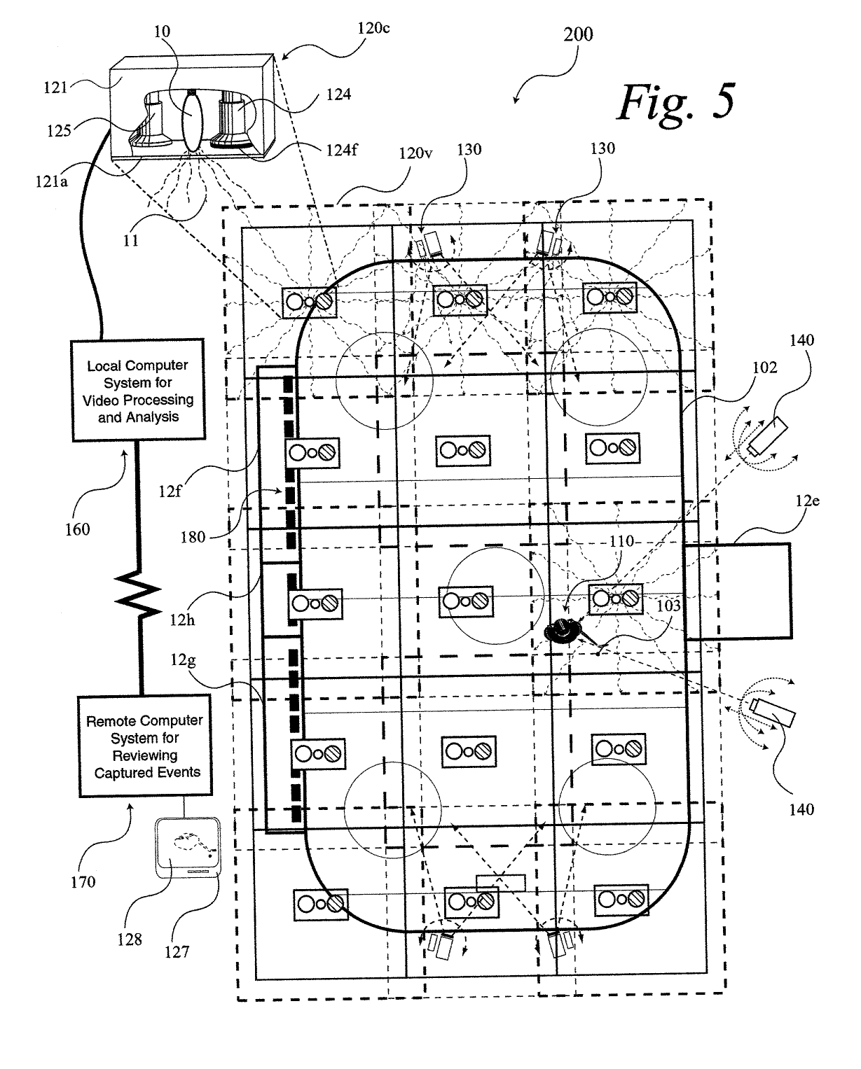

Referring now to FIG. 4a, there is shown a naturally absorptive background 60a upon which at least one naturally reflective object 30 to be tracked transverses. Attached to reflective object 30 are one or more naturally reflective articles 70 and 72. Placed onto object 30 are reflective markers 80 and 84. Placed onto article 72 is reflective marker 82. Also present near object 30 is equipment 74 onto which reflective marker 86 has been placed.

Referring now to FIG. 4b, there is shown naturally absorptive background 60a upon which the naturally reflective object 30 depicted in FIG. 4a has been treated and is now absorptive object 30a. Naturally reflective articles 70 and 72 have also been treated and are now shown as absorptive articles 70a and 72a. Reflective markers 80 and 84 are now shown as placed onto absorptive object 30a while reflective marker 82 is placed onto absorptive article 72a. Furthermore naturally reflective equipment 74 has been treated and is shown as absorptive equipment 74a upon which reflective marker 86 has been placed.

Referring now to FIG. 4c, there is shown naturally absorptive background 60a and object 30. Placed onto reflective object 30 are absorptive markers 80a and 84a as well as reflective articles 70 and 72. Placed onto article 72 is absorptive marker 82a. Near object 30 is reflective equipment 74 unto which absorptive marker 86a has been placed.

Referring to FIG. 5, there is shown a top view drawing of the preferred embodiment of the present invention. System 200 comprises an array of overhead x-y camera assemblies 120c that individually track all object movement within a fixed area such as 120v. In total, the array of overhead assemblies 120c track all movements on ice playing surface 102, and in team boxes 102f and 102g, penalty box 102h as well as a portion of entrance-way 102e. Assembly 120c further comprise filming camera 125, rink lamp 10 such as a Metal Halide HID lamp, tracking camera 124 onto which is attached visible energy filter 124f, all of which is housed in assembly casing 121 and has a view to the ice surface 102 below through assembly Plexiglas 121a. Rink lamp 10 emits unused UV energy 1 such as the UV frequencies emitted by a Metal Halide lamp that radiates down onto surface 102 and off the objects moving upon this surface such as player 110 and puck 103. Also tracking movements on a selected portion of ice surface 102 are perspective z tracking camera sets 130 that are situated as one pair at both ends of the playing surface 102. And finally there are automatic filming cameras 140 which are constantly being directed to the center of play as represented by player 110 who is currently controlling puck 103. Automatic filming cameras 140 are in continuous communications with and are receiving their directions from local computer system for video processing and analysis 160. System 160 itself is also in continuous communications with array of overhead x-y tracking camera assemblies 120c and perspective z tracking camera sets 130. Local system 160 is further in optional communication with remote computer system for reviewing captured events 170 that has attached viewing monitor 127 that displays scene 128.

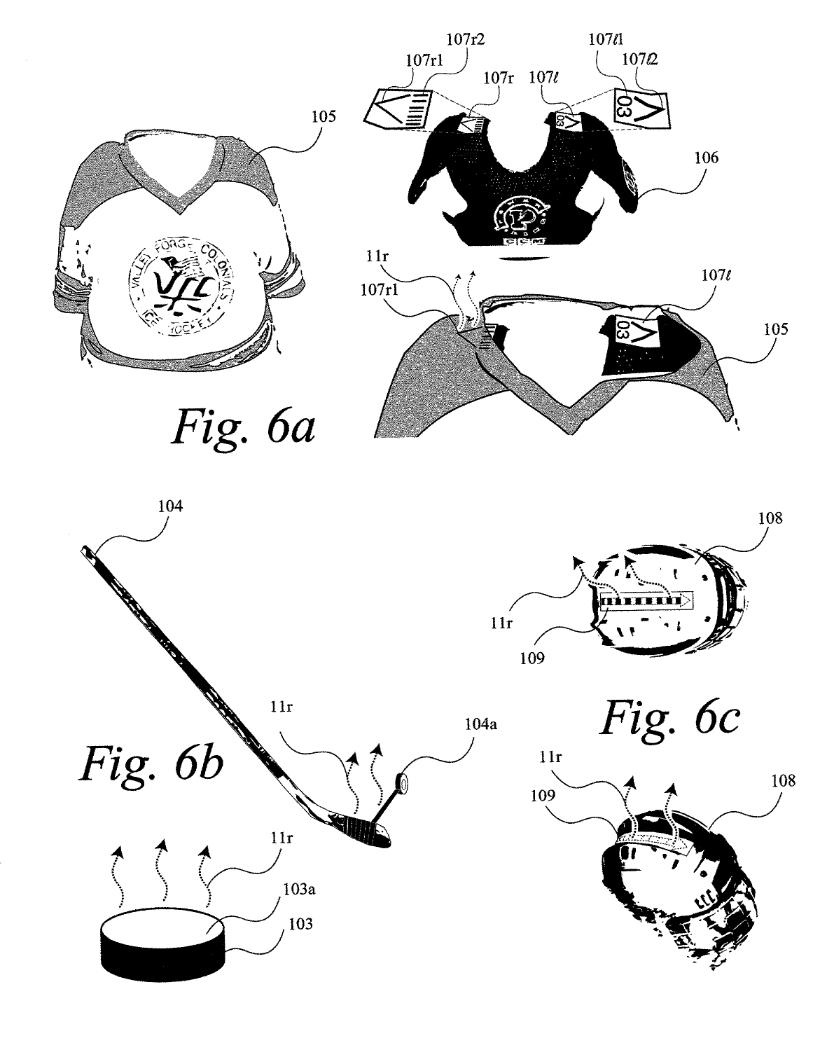

Referring now to FIG. 6a, there is depicted a typical player's jersey 105 and player's shoulder pads 106. Affixed to pads 106 are right shoulder team patch 107r and left shoulder player patch 107l. Patch 107r comprises orientation mark 107r1, which is an arrowhead pointing away from the head towards the arm and team indicia 107r2, which is a unique bar code. Patch 107l comprises orientation mark 107l1 that is an arrowhead pointing away from the head towards the arm and player indicia 107l2 that is a unique number. It should be noted that the indicia on patches 107r and 107l are created from either reflective material 20a, retroreflective material 20b or fluorescent material 20c. Also referring to FIG. 6a, there is depicted jersey 105 placed over pads 106. Note that jersey 105 is also shown to be cut-away for a full view of underlying player patch 107l. Also depicted in FIG. 6a is reflected UV energy 11r, such as reflective rays r1, retroreflected rays r2 or fluorescent rays r3, that is shown radiating though transmissive jersey 105.

Referring now to FIG. 6b, there is shown a typical hockey puck 103 where its top surface (and in practice all outer surfaces) have been coated with a reflective ink 103a such as either reflective material 20a, retroreflective material 20b or fluorescent material 20e. Also depicted is a typical hockey stick 104 where its blade has been wrapped with a special reflective hockey tape 104a that is made of similar reflective material 20a, retroreflective material 20b or fluorescent material 20c. And finally depicted in FIG. 6b is reflected UV energy 11r, such as reflective rays r1, retroreflected rays r2 or fluorescent rays r3, that is shown radiating off both puck 103 and stick 104.

Referring now to FIG. 6c, there is shown both a top and perspective view of a typical hockey player's helmet 108 where a reflective sticker 109 has been applied to its top surface and is made of similar reflective material 20a, retroreflective material 20b or fluorescent material 20c. Also depicted in FIG. 6e is reflected UV energy 11r, such as reflective rays r1, retroreflected rays r2 or fluorescent rays r3, that is shown radiating off helmet 108.

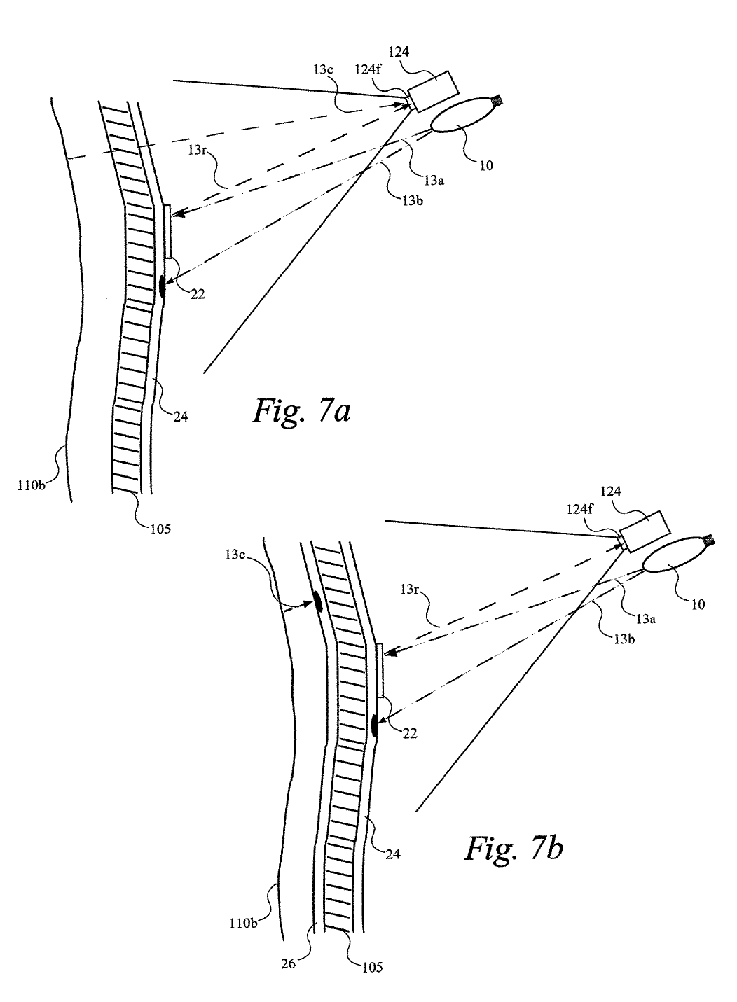

Referring now to FIG. 7a, there is shown a cutaway drawing of player's body 110b that is covered by jersey 105 onto which has been applied an IR energy absorptive compound 24 as well as IR tracking patch 22. Also depicted is tracking camera 124 that has been fitted with visible energy filter 124f as well as rink lamp 10. Being emitted from rink lamp 10 is unused by-product IR energy rays 13a and 13b. Ray 13a is shown to be reflected off patch 22 becoming ray 13r. Player's body 110b is further emitting IR interference ray 13c.

Referring now to FIG. 7b, there is shown a cutaway drawing similar to FIG. 7a except that the inside lining of jersey 105 has been additionally treated with body IR emission absorptive compound 26.

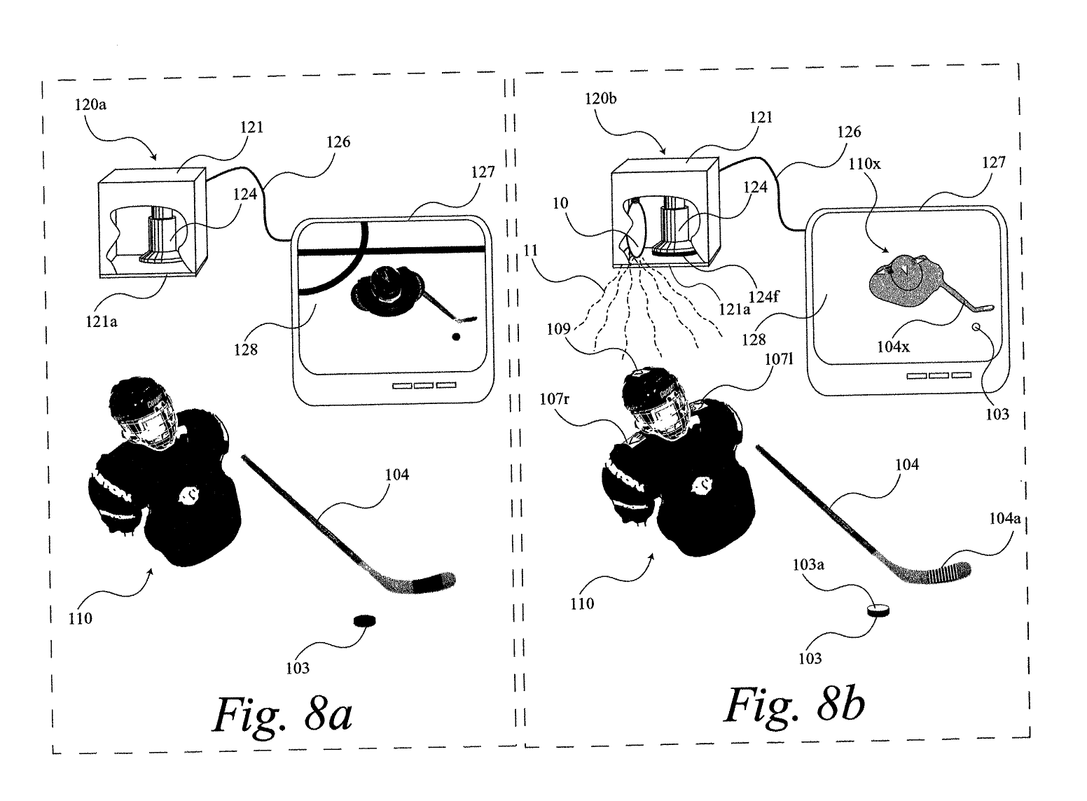

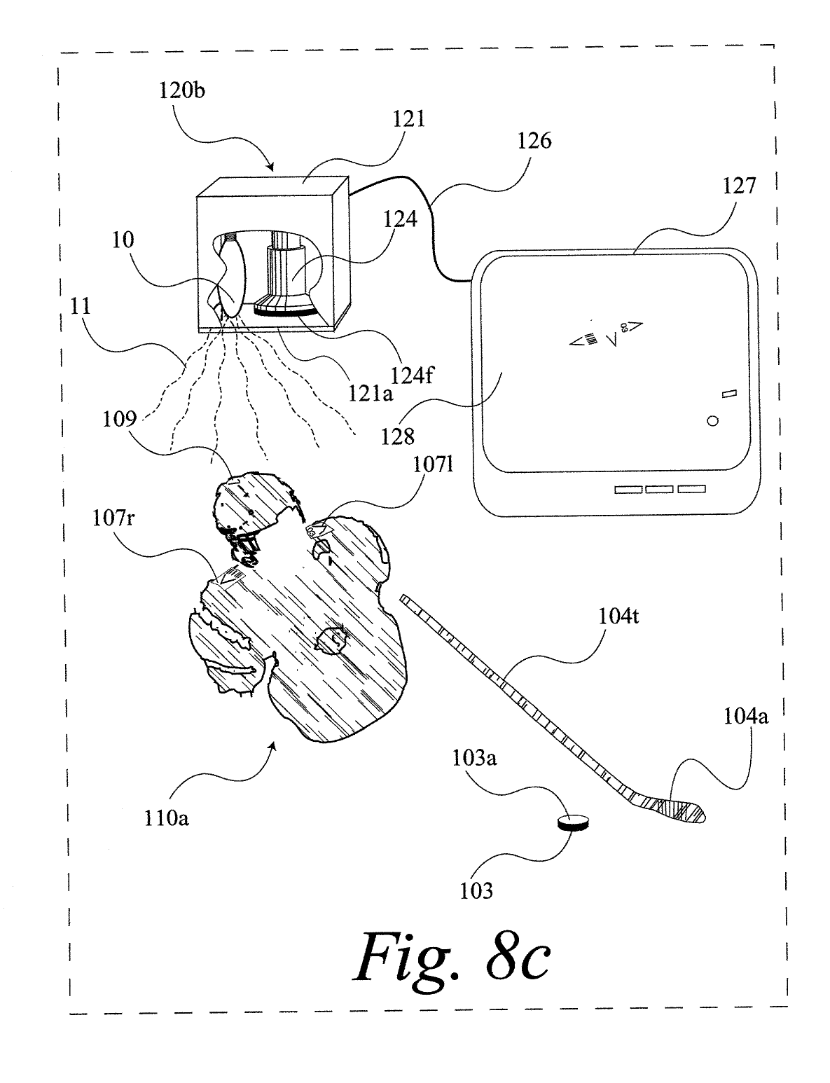

Referring now to FIG. 8a, there is shown a first embodiment of the overhead x-y tracking camera assembly 120a. In this embodiment, assembly 120a includes rink lamp 10 and tracking camera 124 (without visible energy filter 124f) which is enclosed within assembly casing 121 and has a view to the ice surface 102 below through assembly Plexiglas 121a. There is depicted below assembly 120a unmarked player 110, unmarked stick 104 and unmarked puck 103. Also show is cable 126 which attaches assembly 120a to local computer system 160 (not depicted), to remote computer 170 (also not depicted) and therefore to viewing monitor 127 that displays scene 128.

Referring now to FIG. 8b, there is shown a second embodiment of the overhead x-y tracking camera assembly 120b. In this embodiment, tracking camera 124 has been modified to include visible energy filter 124f. Note that player 110's pads 106 have been augmented to include right shoulder team patch 107r and left shoulder player patch 107l. Also note that puck 103 now includes reflective ink 103a and that stick 104 has been wrapped with a special reflective hockey tape 104a. Scene 128 now depicts a different set of information to be analyzed and tracked such as a “dimmed” image of player 110 depicted as player 110x and a “dimmed” image of stick 104 depicted as stick 104x. In addition to these “dimmed” images of the foreground objects, the different set of information also includes “bright” images of the tracking marks that have been placed onto these same foreground objects such as patches 107r and 107l as well as ink marks 103a and tape 104a.

Referring now to FIG. 8c the second embodiment of the overhead x-y tracking camera assembly 120b remains the same while the foreground objects have been additionally treated with a UV absorptive compound. These foreground objects are now shown as player 110a and stick 104t. Note that in scene 128 player 110a and stick 104t are no longer visible.

Operation

It should first be noted that operation of system 200 is similar to that of system 100 as described by the present inventors in their co-pending application entitled Multiple Object Tracking System, U.S. application Ser. No. 09/197,219, with the following exceptions:

1) “Energy source 23” from the co-pending application has been replaced by “existing rink lamp 10” that might typically be a Metal Halide HID lamp but could also be a Zenon Arc or other type of lamp.

2) “Selected energy 23a” that was emitted from “energy source 23” as specified in the co-pending application is now “unused UV energy 11” as emitted from rink lamp 10 and could have also been likewise replaced by “unused IR energy 13.”

3) “Reflected energy 7m”, “3b”, “4b”, “9a” and “11b” from the co-pending application are now “reflected UV energy 11r” and could have also been likewise replaced by reflected IR energy 13r.

4) “Frequency selective reflective material used in patches 7r and 7l”, “reflective ink 3a”, “special reflective ink” (used to create) “special reflective hockey tape 3a”, “special reflective ink” (used to create) “reflective sticker 9” and “reflective ink 11a” could be any of either “reflective material 20a,” “retroreflective material 20b” or “fluorescent material 20c.”

5) “Energy filter 24f” is now more precisely referred to as “visible energy filter 124f.”

6) Specifically tracked objects such as player 110, stick 104, puck 103, jersey 105, pads 106 and helmet 108 are now also generally referred to as “naturally reflective objects and articles” such as 30, 70, 72 and 74. These same “naturally reflective objects and articles” are then additionally shown as “absorptive objects and articles” 30a, 70a, 72a and 74a after they have been treated with one of a range of UV absorptive compounds.

7) Tracking energy absorptive compounds such as 24 have been specified to change the reflective properties of foreground objects such as player's jersey 105. Also, tracking energy absorptive compounds such as 26 have been applied to the inside surface of foreground objects such as jersey 105 in order to change the object's tracking energy transmissive properties thereby reducing and/or eliminating any stray interference caused by the player's 110 own energy emissions.

Only the main points of system 200's operation shall be reviewed since it is similar to system 100 of the co-pending application so that the present inventors may focus on the differences between the two systems.

Referring first to FIGS. 5, 6 and 7, normal operation of the preferred embodiment commences after system 200 has been properly installed at an ice arena in a similar fashion as system 100 from the co-pending application except that additional energy sources “23” are not installed in favor of existing rink lamps 10.

Referring now to FIGS. 6a, 6b and 6c as well as FIGS. 1, 2a, 2b, 2c the preferred embodiment provides for various methods of marking the objects to be tracked with a specially chosen frequency selective reflective material such as any of “reflective material 20a,” “retroreflective material 20b” or “fluorescent material 20c.” These materials are then used to embed into puck 103 as reflective ink 103a, to produce reflective tape 104a, to embed into markings of patches 107r and 107l, and to produce reflective stickers 109 for helmets 108. Of these various types of materials, i.e. “reflective 20a,” “retroreflective 20b” and “fluorescent 20c,” the “retroreflective 20b” type appears to offer the greatest conservation of emitted unused energy 11 or 13 by causing the least amount of dispersion upon reflection. It should be noted that the retroreflective inks that are commercially available are designed to reflect visible light 12 for human eye applications. However, these same inks and paints additionally reflect non-visible frequencies such as UVA 11 or near IR 13. It is this additional unused reflective ability of these inks that the present inventors are applying in order to maximize the reflected non-visible energy 11r into the tracking cameras 124 through visible energy filter 124f. By using specially matched visible energy filter 124f on each camera 124, the “noise” caused by the detection of reflected visible energy 12 by cameras 124 is eliminated thereby reducing the need to emit a stronger non-visible energy signal 11 or 13.

Referring again to FIG.'s 6a, 6b and 6c as well as FIG.'s 3a, 3b, 4a and 4b a second type of system “noise” is significantly reduced or eliminated by treating the objects such as puck 103, stick 104, pads 105, jersey 106 and helmet 108 to which the tracking inks, patches and stickers such as 103a, 103a, 107r, 107l and 109 have been applied with a compound capable of absorbing the non-visible tracking energy. As previously discussed in the background section of this application, for UV energies in particular many such compounds exist any one or more of which may be applied to skin, fabric, leather, plastic, rubber, wood, metal and other materials. The present inventors are aware of at least three such commercially available materials as follows:

1 “Protectall” manufactured by Protectall, Inc.,

2 “Tri-Absorb UV Blocker” manufactured by Tri-Plex, and

3 “Hawaiian Tropic” manufactured by Tanning Research Labs, Inc.

These compounds all act in a similar manner to absorb UV energy on the surface of the material to which they have been applied. As can be seen in both FIGS. 3a and 4a, naturally reflective objects such as 30, 70, 72 and 74 will exist within the tracking camera's field of view. For the sport of ice hockey, objects such as 30, 70, 72 and 74 might typically represent a player's jersey 105, their stick 104 or helmet 108 and/or the puck 103. After applying the appropriate absorptive compound, naturally reflective objects and articles 30, 70, 72 and 74 that are “tracking energy visible” now become absorptive objects and articles 30a, 70a, 72a and 74a that are “tracking energy invisible.” Note that tracking markers 80, 82, 84 and 86 remain “tracking energy visible.” For the sport of ice hockey, tracking markers such as 80, 82, 84 and 86 might typically represent puck ink 103a, stick tape 104a, pad patches 107r and 107l or helmet sticker 109. It should be further noted that these UV absorptive compounds were designed to protect the materials to which they were applied from the harmful effects of UV energy such as skin or tissue damage in humans or pigment fading in fabrics and other surfaces. Their property of absorbing UV energy is being uniquely exploited by the present inventors in order to reduce the unwanted UV reflections 11r that may be received by tracking camera's 124 through filters 124f. This second reduction in system “noise” further reduces the need to emit a stronger non-visible energy signal 11 or 13.

Also referring to FIGS. 3a, 3b, 3c, 4a, 4b and 4c there is depicted all of the potential combinations of tracking backgrounds 60 and 60a, tracked objects and articles 30, 30a, 70, 70a, 72, 72a, 74 and 74a as well as tracking markers 80, 80a, 82, 82a, 84, 84a, 86 and 86a. Specifically, each figure element ending in “a” such as 60a is meant to represent a tracking energy absorptive background, object, article and/or marker while those figure elements without an “a” such as 60 are tracking energy reflective. Typically, the energy absorptive/reflective property of the background or playing venue will tend to dictate the optimal absorptive/reflective properties of the objects and tracking markers in order to create the ideal “signal to noise” ratio. In the case of ice hockey, the ice surface 102 is UV reflective as depicted by background 60. The present inventors anticipate the application of UV reflective pigments and/or materials into the ice surface to further increase the UV reflectivity of ice surface 102. Alternatively, in order to reduce UV reflectivity it is possible to add an absorptive compound into surface 102. This second option is particularly appealing when the foreground objects are also being treated with absorptive compounds. The combined effect being to eliminate all UV reflective signals received by camera 124 except for the reflective markings. In either case, whether adding reflective or absorptive material to the ice surface, the application of the chosen material is expected to be easily accomplished by mixing the compound with the water that is applied by a Zamboni machine during the ice resurfacing process. In the case of sports such as soccer, football or baseball, the natural or artificial grass surfaces are UV absorptive as depicted by background 60a. The present inventors anticipate the application of UV reflective and absorptive pigments and/or materials into these types of playing surfaces to further increase their UV reflectivity and absorption respectively.

In a similar manner and as already discussed, by selectively applying either tracking energy reflective or absorptive compounds to the naturally reflective objects and articles such as 30, 70, 72 and 74 or the tracking markers such as 80, 82, 84 and 86 their “tracking contrast” may be accentuated from each other as well as the backgrounds 60 and 60a. This “contrast” is the “signal to noise” ratio that has a direct bearing on the required energy level of the tracking signal as well as the performance of the tracking system.

To further illustrate the novelty of the present invention especially in regard to the previously mentioned Multiple Objet Tracking System refer now to FIGS. 8a, 8b and 8c. FIG. 8a shows a conventional visible light camera system 124 and its corresponding field of view as scene 128 on monitor 127. Note that in this view there is considerably more information that must be processed including a foreground object such as player 110, stick 104 and puck 103. In FIG. 8b, camera 124 has been fitted with visible energy filter 124f thereby eliminating all reflected visible light information off the foreground objects such as player 110, stick 104 and puck 103. However, foreground objects such as player 110, stick 104 and puck 103 are naturally reflective objects and articles that will cause a “dimmed” image to be received through visible light filter 124f into camera 124 based upon reflected UV energy 11r. This dimmed image is represented by partially visible player 110x and partially visible stick 104x and was not anticipated by the prior co-pending application. Note that reflective materials as previously discussed in the form of 103a, 104a, 107r, 107l and 109, have also been added to puck 103, stick 104 and player 110 for tracking purposes and will typically show up “brighter” than naturally reflective foreground objects such as 110, 103 and 104.

Referring now to FIG. 8c, the only change is the treatment with the appropriate UV absorptive materials to player 110's jersey 105 and helmet 108 as well as stick 104. As a result of this application, the partially visible player and stick images 110x and 104x respectively have been eliminated as depicted in scene 128 from FIG. 7c.

Referring now to FIG. 7a, there is shown an additional source of system noise that is expected when IR is used as a tracking energy. Specifically, the human body as represented by 110b is known to emit energy in the IR spectrum such as interference ray 13c. Furthermore, jersey 105 is expected to be transmissive to interference ray 13c that will then be potentially received into tracking camera 124 through filter 124f. In order to reduce and/or eliminate this additional source of system noise, the present inventors propose treating the inside of jersey 105 with an IR absorptive compound 26 as depicted in FIG. 7b. Once applied, compound 26 absorbs most or all of interference ray 13c thereby reducing system noise. This additional reduction in noise lessens the requirement to add more IR tracking energy thereby beneficially minimizing the overall system energy requirements. Note that the present inventors anticipate accomplishing this same goal of reducing or eliminating system noise from stray body emissions by alternately employing an IR reflective compound inside jersey 105 rather than absorptive compound 26. By using a reflective compound, energy rays such as 13c would reflect back off the inside of jersey 105 into player's body 110b from which they were emitted.

All other elements of the apparatus of the present invention are identical to the system previously described in the co-pending Multiple Object Tracking System patent application. This includes the additional perspective tracking cameras as well as the additional automatic filming cameras. The actual operation of the system 200 is also identical to that described in the co-pending application and is intentionally not repeated here for brevity.

However, to best emphasize the novel aspects of the present invention the following excerpt is repeated from the co-pending application:

“As each frame from tracking camera 24 of overhead assembly 20c1 is accepted by analysis unit 62, the gray scale of each pixel is compared against a threshold value where those pixels exceeding the threshold indicate the presence of any form of the special mark such as 3a, 4a, 7r, 71 and 9.”

Assuming that a pixel gray scale gradient value of “0” represented black, or no signal, and the gradient value of “255” represented white, or complete signal, than the ideal object tracking system would not have any pixels of a value “1” through “254.” In practice this is typically not the case. The prior co-pending application attempted to move closer to this ideal by filtering out the visible light that was being reflected off the foreground objects and by specifically choosing a material that was highly reflective of the tracking energy (e.g., Ultraviolet or Infrared) and placing this material on the desired tracking points of the foreground objects. To the extent that the differentiation between the reflected tracking energy being received off this special material versus that being received off the foreground objects was less than maximum, it becomes necessary to consider various methods of increasing this differentiation. The present invention focuses on techniques for optimizing this “signal to noise ratio” while at the same time minimizing the amount of additional tracking energy that must be added by the system since additional energy has an overall detrimental effect.

The reiterations of the novel teachings of the present invention are as follows:

1. Energy is conserved by employing the unused non-visible frequencies already being emitted by the existing lighting such as Metal Halide Lamp 10 as opposed to adding new lamps such as “energy source 23” specified in the co-pending application. The present inventors are claiming this new use of the by-product non-visible energy of Metal Halide Lamps employed to illuminate sport arenas in particular and other similar types of arena lamps in general.

2. Unwanted tracking energy reflections off naturally reflective foreground objects such as player 110, stick 104, puck 103 and helmet 108 are reduced and/or eliminated by treating the objects with one or several compounds commercially available for absorbing selected bands of energy such as UV. The present inventors are claiming this new use of such existing compounds for the purpose of absorbing the non-visible energy within an object tracking system.

3. Desired tracking energy reflections 11r or 13r off the tracking markers, inks and patches are now increased by the use of retroreflective or fluorescent materials such as 20b or 20c respectively. Note that the co-pending application already called for the use of reflective materials such as 20a. The present inventors are claiming this new use of such retroreflective and fluorescent materials for purpose of increasing the signal in a non-visible energy tracking system.

4. Unwanted interference caused by stray IR energy emitted from the player's body 110b and transmitted through jersey 105 into tracking camera 124 is now reduced or eliminated by applying either an IR absorptive compound 26 or an IR reflective compound such as 20 to the inside lining of jersey 105. The present inventors are claiming the new use of such IR absorptive or reflective compounds for the purpose of reducing noise in an IR based object tracking system.

Conclusion, Ramifications, and Scope of invention

Thus the reader will see that the present invention provides a novel apparatus and method for:

1 employing the unused by-product non-visible energy such as UV or IR already being emitted by the visible lighting system currently in place at a given arena or facility thereby reducing or eliminating the requirement to add additional tracking energy;

2 converting the existing visible frequencies of light already being emitted by the lighting system currently in place at a given area into preferably a non-visible tracking frequency such as IR thereby reducing or eliminating the requirement to add additional tracking energy;

3 reducing the noise created by emitted tracking energy reflecting off object surfaces that are not intended to be tracked;

4 reducing the noise created by interfering electromagnetic frequencies being emitted by tracked objects such as a player that overlap the tracking energy frequencies;

5 increasing the signal received by the tracking cameras as reflected off the object surfaces that are intended to be tracked; and

6 implementing a system that has minimal to no negative energy effect on the arena or facility into which it is placed.

While the above description contains many specifications, these should not be construed as limitations on the scope of the invention, but rather as an exemplification of preferred embodiments thereof. Many aspects of the system's functionality are beneficial by themselves without other aspects being present. For instance:

1 Lamps specifically emitting a non-visible energy such as UVA or Infrared could still be used in place of or in addition to the existing rink lamps without negating the value of using retroreflective or fluorescent materials in place of reflective materials to mark the objects to be tracked. Similarly, these lamps do not negate the value of using non-visible energy absorbing compounds to either lessen the reflections off foreground surfaces not intended to be tracked or lessen the noise created by foreground object electromagnetic radiation.

2 Vice versa is also true in that the use of reflective materials as originally suggested in the co-pending application as opposed to either retroreflective or fluorescent does not negate the value of using the by-product non-visible energy of the existing rink lamps or the non-visible energy absorptive properties of certain compounds.

3 Also, the foreground surfaces do not need to be treated with the non-visible energy absorptive materials in order to gain value by using the by-product energy from the existing rink lamps and/or the retroreflective or fluorescent materials.

4 The foreground objects may emit electromagnetic frequencies that overlap the selected tracking energy but may not be of sufficient power to create any appreciable system noise and therefore may not require a compound to reflect them back into the foreground object.

5 To the extent that other types of visible light lamps exist such as Mecury Vapor and High-Pressure Sodium that also emit by-product electromagnetic radiation, these could be used in place of Metal Halide Lamps.

6 To the extent that compounds exist the can be applied to one or more of the various surfaces found within the sporting events to be tracked that will absorb IR energy, then these can be used in a fashion similar the UV absorbent compounds.

7 The energy absorptive compounds typically found in the commercial marketplace are often a combination of base material to which a UV absorber has been added. Often this base includes other surface treatments that may for instance provide weatherproofing, conditioning, color restoration, etc. While these other surface treatments are typically the most significant feature of the commercial product they are not in any way critical to the present application. The present inventors anticipate that it would be possible to create a simple base material that did nothing more than act as a binder to which UV or IR absorbent compounds could then be added. This anticipated material would be sufficient for the teachings of the present invention.

8 The techniques of applying specific energy absorptive compounds to the foreground objects in order to reduce system noise can also be implemented with the tracking backgrounds such as either the ice surface or a grass surface.

It is evident from the description of the present invention that it has applicability beyond that of tracking the movements of hockey players and the puck during an ice hockey game. For example, this same system could be set up over an outside roller hockey rink if the frame which holds the overhead assemblies were itself to be mounted on posts or polls to hold it above the playing area. The system could also be used to track basketball in a fashion very similar to ice hockey since these games are nearly always played in an indoor arena. Similar approaches could be used with other sports such as football, baseball and soccer as long as the field of view is sufficiently covered with perspective tracking cameras because there will not be any overhead assemblies. The system could also be used in large convention halls or auditoriums to track security whereabouts, attendee flow and the location of support staff. This could be accomplished by using the same overhead tracking cameras while the filming cameras would more than likely be unnecessary. Each type of person to be tracked could be asked to wear a special patch that could even be coded based upon statistically relevant criteria as determined by the event hosts. As individuals with patches moved about and visited different booths, their choices could automatically be tracked including their time spent at each selected both. Such a system could also help with crowd flow if large lines where detected as forming around selected areas. Note that in this application, it is less critical that each and every movement of each and every person to be tracked is followed, but rather that in total the majority of movements of all like individuals are determined from which helpful decisions and statistics might be derived.

From the foregoing detailed description of the present invention, it will be apparent that the invention has a number of advantages, some of which have been described above and others that are inherent in the invention. Also, it will be apparent that modifications can be made to the present invention without departing from the teachings of the invention. Accordingly, the scope of the invention is only to be limited as necessitated by the accompanying claims.

We claim:

1. An automated system for following the movement of one or more marks placed upon one or more objects within a predefined area, the system comprising:
one of retroreflective and a fluorescent ink forming at least one mark placed upon at least one object;
means for radiating energy throughout the predefined area;
means for receiving energy emanating from the one or more marks in response to the radiated energy; and
means responsive to the receiving means for determining the location of the one or more marks and therefore the location of the one or more objects onto which the marks have been placed.

2. An automated system for following the movement of one or more marks placed upon one or more objects within a predefined area, the system comprising:
one of retroreflective and a fluorescent ink forming at least one mark placed upon at least one object;
one or more lamps for radiating energy throughout the predefined area;
one or more video cameras for receiving energy emanating from the one or more marks in response to the radiated energy; and
a computer network responsive to the receiving means for determining the location of the one or more marks and therefore the location of the one or more objects onto which the marks have been placed.

3. An automated system for following the movement of one or more marks placed upon one or more objects within a predefined area illuminated by one or more lamps emitting visible light non-visible energy, the system comprising:
one of a reflective, retroreflective, and fluorescent ink forming at least one mark placed upon at least one object;
means for receiving energy emanating from the at least one mark in response to the non-visible energy being radiated by the lamps; and
means responsive to the receiving means for determining the location of the one or more marks and therefore the location of the one or more objects onto which the marks have been placed.

4. An automated system for following the movement of one or more marks placed upon one or more objects within a predefined area illuminated by one or more lamps emitting visible light and non-visible energy, the system comprising:
one of a reflective, retroreflective, and fluorescent ink forming at least one mark placed upon at least one object;
one or more visible light filtered cameras for receiving energy emanating from the at least one mark in response to the non-visible energy being radiated by the lamps; and
a computer network responsive to the receiving means for determining the location of the one or more marks and therefore the location of the one or more objects onto which the marks have been placed.

5. A system for reducing unwanted reflections of a selected energy off either foreground or background objects in a tracking, measurement, or identification apparatus, the system comprising:
a compound capable of absorbing selected energy; and
an applique for holding the absorbent compound on either foreground or background objects.

6. A system for reducing unwanted emissions of a selected energy from a foreground object in a tracking, measurement, or identification apparatus or from a material covering the foreground object, the system comprising:
a compound capable of either absorbing or reflecting the selected energy; and
an applique for holding the compound onto either the foreground object itself or onto the material covering the foreground object.
